(19) United States
(12) Patent Application Publication
(10) Pub. No.: US 2026/0066382 A1
(43) Pub. Date: Mar. 5, 2026

(54) BATTERY PACK

(71) Applicant: TOYOTA JIDOSHA KABUSHIKI KAISHA, Toyota-shi (JP)

(72) Inventors: Kohei TAKASE, Susono-shi (JP); Kenichi KOHASHI, Shizuoka-ken (JP)

(73) Assignee: TOYOTA JIDOSHA KABUSHIKI KAISHA, Toyota-shi (JP)

(21) Appl. No.: 19/217,371

(22) Filed: May 23, 2025

(30) Foreign Application Priority Data
Aug. 29, 2024 (JP) 2024-147543

(51) Int. Cl. H01M 10/655; H01M 10/04; H01M 10/613

(52) U.S. Cl. CPC H01M 10/655; H01M 10/0481; H01M 10/613

(57) ABSTRACT

A battery pack includes a battery stack and a band body that binds battery cells of the battery stack between the battery stack and a cooler that cools the battery cells. In the battery pack, a plurality of heat conductive sheets is provided between the battery cells and the band body and between the cooler and the band body. Between the battery cells and the band body, one end portion of each curved heat conductive sheet is brought into surface contact with and joined to the battery cells, and another end portion thereof is brought into surface contact with and joined to the band body. Thereby, even when a curve or the like arises on the band body and distances between the battery cells and the band body vary, since elastic deformation of the heat conductive sheets follows, deterioration of cooling efficiency for the stacked battery cells can be restrained.

### CROSS-REFERENCE TO RELATED APPLICATION

This application claims priority to Japanese Patent Application No. 2024-147543 filed on Aug. 29, 2024. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

A battery module disclosed in Japanese Unexamined Patent Application Publication No. 2013-218930 (JP 2013-218930 A) has battery cells for which laminate lithium secondary batteries are used, a plate including a material that can mediate heat conduction from and to each of the battery cells, and a heat exchange portion in which heat exchange is performed from and to the plate. Moreover, in the battery module, a heat diffusion sheet to which a graphite sheet or the like is applied is interposed between the battery cell and the plate, and in the battery module, heat of the battery cell is diffused by the heat diffusion sheet, and temperature differences between the battery cells are restrained from arising.

### SUMMARY

Now, in a battery pack in which a plurality of battery cells is stacked, a binding band for which iron or the like is used is provided on one of surfaces in a direction intersecting the stacking direction, and the binding band binds the stacked battery cells. Moreover, in the battery pack, a cooler for cooling the battery cells is occasionally arranged on the surface on which the binding band is arranged. In such a battery pack, heat conductive materials are pasted between the battery cells and the binding band, between the battery cells and the cooler, and between the binding band and the cooler. Thereby, in the battery pack, heat generated from the battery cells in charging and in discharging is conducted to the cooler via the heat conductive materials to be radiated from the cooler, and thereby, the battery cells are cooled.

In the battery pack, by the binding band restraining the length of the stacked body in the stacking direction from varying, there however occasionally arise undulations on the binding band and the surface in the direction intersecting the stacking direction of the stacked body, caused by expansion and contraction of the battery cells in charging and in discharging. This causes concern that, with the battery pack, the heat conductive materials are peeled off from and/or crack on the battery cells, the binding band, or the cooler, and by the heat conductive materials suffering peeling-off or similar action from the battery cells, the binding band, or the cooler with the battery pack, cooling efficiency for the battery cells deteriorates, and battery performance deteriorates.

The present disclosure is devised in view of the aforementioned facts, and an object thereof is to provide a battery pack with which cooling efficiency for stacked battery cells is restrained from deteriorating.

In order to attain the aforementioned object, a battery pack of a first aspect of the present disclosure includes: a stacked body including a plurality of battery cells in a stacking direction; a cooling member facing at least one surface of surfaces of the stacked body, the surfaces being in a direction intersecting the stacking direction, the cooling member being configured to cool the battery cells on a side of the one surface; a binding member that compresses the stacked body at both end portions in the stacking direction to bind the battery cells, the binding member being disposed between the stacked body and the cooling member, the binding member being in a strip shape; and a heat conduction portion that allows heat to be conducted between the battery cell and the cooling member via a heat conductive member that is in a sheet shape, one side of the heat conductive member in a planar direction being joined to a side of the battery cell, another side of the heat conductive member in the planar direction being joined to a side of the cooling member, an intermediate portion of the heat conductive member being in a curved shape, the one side, the other side, and the intermediate portion being between the battery cell and the cooling member.

The battery pack of the first aspect includes the stacked body including the battery cells in the stacking direction, the cooling member faces the at least one surface of the surfaces of the stacked body, the surfaces being in the direction intersecting the stacking direction, and the cooling member cools the battery cells on the facing surface. Moreover, the binding member is disposed between the stacked body and the cooling member, and the binding member is in the strip shape and compresses the stacked body at both end portions in the stacking direction to bind the battery cells.

In the heat conduction portion between the battery cell and the cooling member, the heat conductive member that allows heat to be conducted between the battery cell and the cooling member is disposed, the heat conductive member is in the sheet shape, the one side in the planar direction is joined to the battery cell side, the other side is joined to the cooling member side, and the intermediate portion is in the curved shape. When the binding member is disposed between the battery cell and the cooling member, the one side of the heat conductive member is joined to the battery cell, and the other side is joined to the binding member. Moreover, between the binding member and the cooling member, the one side of the heat conductive member is joined to the binding member, and the other side is joined to the cooling member.

Therefore, even when a curve arises on the binding member caused by expansion and contraction of the battery cell and the distance between the battery cell and the binding member and the distance between the binding member and the cooling member vary, since the heat conductive member can be deformed so as to follow the changes, peeling-off and/or cracks are restrained from occurring on the joined portions of the heat conductive member. Accordingly, cooling efficiency for the battery cells can be restrained from deteriorating, and a battery function can be restrained from deteriorating.

In the first aspect, as to the battery pack of a second aspect, in the heat conduction portion, a plurality of the heat conductive members may be disposed in the stacking direction of the battery cells, and the heat conduction portion may include a heat conduction plate that thermally connects the heat conductive members, the heat conduction plate being configured to enable heat to be conducted between the heat conductive members.

In the battery pack of the second aspect, in the heat conduction portion, the heat conductive members may be disposed in the stacking direction of the battery cells. Moreover, in the heat conduction portion, the heat conduction plate may be disposed. The heat conduction plate may thermally connect the heat conductive members to conduct heat between the heat conductive members. Thereby, the temperatures of the battery cells can be made uniform, and cooling efficiency for the battery cells can be effectively restrained from deteriorating.

In the first or second aspect, as to the battery pack of a third aspect, the heat conductive member may be disposed between the battery cell and the binding member and between the binding member and the cooling member, and the heat conductive member may be enabled to be elastically deformed according to changes of a distance between the battery cell and the binding member and a distance between the binding member and the cooling member.

In the battery pack of the third aspect, the heat conductive member may be disposed between the battery cell and the binding member and between the binding member and the cooling member. Moreover, the heat conductive member may be enabled to be elastically deformed, and the heat conductive member may be elastically deformed according to the changes of the distance between the battery cell and the binding member and the distance between the binding member and the cooling member. Thereby, peeling-off or the like can be restrained from occurring on the joined portion of the heat conductive member, and cooling efficiency for the battery cells can be more effectively restrained from deteriorating.

According to the present disclosure, since the heat conductive member in a sheet shape is deformed to be curved and is disposed between the battery cells and the cooling member, there is obtained an effect that peeling-off or the like can be restrained from occurring on the heat conductive member and the battery cells can be kept effectively cooled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic configurational view of a battery pack according to a first embodiment in lateral view;

FIG. 1B is a schematic sectional view of a main portion of the battery pack, the view being taken along the 1B-1B line in in FIG. 1A;

FIG. 2A is a schematic sectional view of a main portion of a battery pack according to Modification 1;

FIG. 2B is a schematic sectional view of a main portion of a battery pack according to Modification 2;

FIG. 3A is a schematic configurational view of a battery pack according to Modification 3 in lateral view;

FIG. 3B is a schematic sectional view of a main portion of the battery pack, the view being taken along the 3B-3B line in FIG. 3A;

FIG. 4A is a schematic configurational view showing an example of a battery pack according to Modification 4 in lateral view;

FIG. 4B is a schematic configurational view showing another example of the battery pack according to Modification 4 in lateral view;

FIG. 5A is a schematic configurational view of a battery pack according to a second embodiment in lateral view;

FIG. 5B is a schematic sectional view of a main portion of the battery pack, the view being taken along the 5B-5B line in FIG. 5A;

FIG. 6A is a schematic configurational view of a main portion of a battery pack according to a third embodiment in lateral view; and FIG. 6B is a plan view showing a main portion of a heat conduction plate in FIG. 6A as viewed from a battery stack side.

### DETAILED DESCRIPTION OF EMBODIMENTS

Hereafter, a battery pack and a cooling structure of a battery pack according to an embodiment of the present disclosure will be described in detail with reference to the drawings.

### First Embodiment

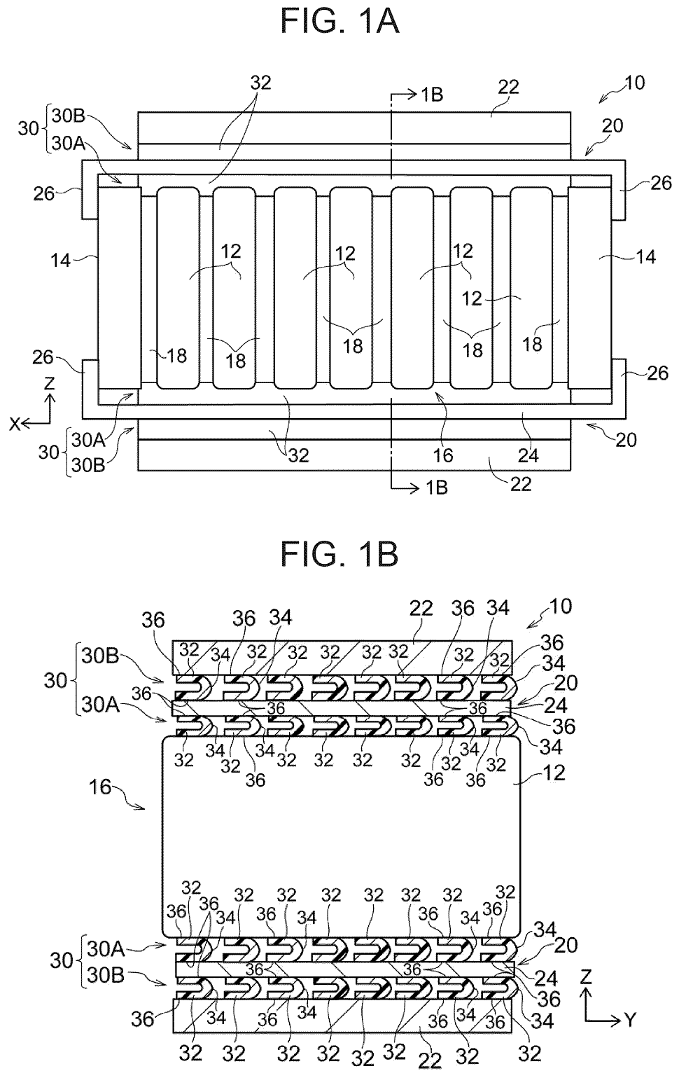

FIG. 1A shows a battery pack 10 according to a first embodiment as a schematic configurational view in lateral view, and FIG. 1B shows a schematic section of a main portion of the battery pack 10 according to the first embodiment as a sectional view taken along the 1B-1B line in FIG. 1A. Note that, in the drawings, one side of a stacking direction as one direction is denoted by the arrow X, and one direction in a direction intersecting the stacking direction is denoted by the arrow Z. In the description below, the arrow Z is oriented to be upward in an up-down direction of the battery pack 10. Moreover, a direction intersecting the stacking direction and the up-down direction is oriented to be in a width direction of the battery pack 10, and in the drawings, one side of the width direction is denoted by the arrow Y.

The battery pack 10 includes one or a plurality of battery modules and is housed in a not-shown case. In the first embodiment, as an example, the battery pack 10 including one battery module is exemplarily described.

For example, the battery pack 10 is mounted on a vehicle including a motor (electric motor) as a drive source for travelling, and outputs direct current electric power that can be applied to driving the motor. Examples of the vehicle that the battery pack 10 is mounted on include a hybrid electric vehicle (HEV), a plug-in hybrid electric vehicle (PHEV), and a battery electric vehicle (BEV).

As shown in FIG. 1A, the battery pack 10 includes a plurality of battery cells 12 and a pair of end plates 14. The battery cells 12 have predetermined thicknesses and are substantially rectangular as viewed through the stacking direction (thickness direction), and the battery cells 12 are arranged in the stacking direction to form a battery stack 16 as a stacked body. The battery cells 12 are connected in series or connected in parallel in the battery stack 16, and the battery pack 10 can output the direct current electric power at a predetermined voltage.

Secondary batteries such as lithium-ion batteries are applied to the battery cells 12. Note that, not limited to the lithium-ion batteries, various secondary batteries such as all-solid-state batteries, lead-acid batteries, nickel-cadmium batteries, and nickel-metal hydride batteries may be applied to the battery cells 12. Moreover, without limitation to the secondary batteries, primary batteries such as manganese dry batteries, graphite fluoride-lithium primary batteries, and manganese dioxide-lithium primary batteries may be applied to the battery cells 12.

In the battery stack 16, one of the end plates 14 is arranged on one side of the battery cells 12 in the stacking direction, and the other of the end plates 14 is arranged on the other side of the battery cells 12 in the stacking direction, they being stacked on the battery cells 12. Moreover, in the battery stack 16, intercell members 18 are arranged in respective spaces between the battery cells 12 that are adjacent in the stacking direction and between each of the end plates 14 and the corresponding one of the battery cells 12. A heat insulating material and the like are used for the intercell members 18, and when, between adjacent two of the battery cells 12 in the stacking direction, one of the battery cells 12 exhibits abnormally high temperature for some reason, the intercell members 18 employ such a heat insulating material, and thereby, restrains the other of the battery cells 12 from being accordingly heated. Note that each of the intercell members 18 only has to have a configuration capable of restraining the temperature rise of the other cell due to heat conduction, and may include a configuration capable of promoting cooling of the battery cells 12.

In the battery pack 10, binding bands 20 each being as a binding member, and coolers 22 each being as a cooling member for cooling the battery cells 12 are arranged. The binding bands 20 and the coolers 22 are arranged on an upper side surface and a lower side surface, each of the surfaces being as a surface of the battery stack 16, the surface being in a direction intersecting the stacking direction of the battery cells 12. The binding bands 20 are attached to the battery stack 16, and the coolers 22 are arranged on the upper side and the lower side of the binding bands 20.

Note that, in the first embodiment, as an example, the binding bands 20 and the coolers 22 are arranged on the upper side surface and the lower side surface of the battery stack 16, and nonetheless, the binding bands 20 and the coolers 22 only have to be arranged on at least one surface in a direction intersecting the stacking direction and may be arranged on a lateral side surface.

Each of the binding bands 20 is metal-made using iron or the like which high load-bearing capacity can be obtained from. The binding band 20 includes a strip-shaped or belt plate-shaped band body 24, and bent portions 26 formed by bending both end portions of the band body 24 in a longitudinal direction.

In each of the binding bands 20, the longitudinal direction is the stacking direction of the battery cells 12, the band body 24 faces the battery stack 16, and each of the bent portions 26 is brought into contact with an outer side surface of the end plate 14 in the stacking direction to be disposed thereon. Moreover, in the binding band 20, the bent portions 26 are fastened and fixed (where another fixation method such as adhesive fixation may be employed) to the end plates 14 to be attached to the battery stack 16 and be assembled to the battery pack 10.

By the bent portions 26 giving external forces in such directions that the end plates 14 come close to each other, the binding bands 20 bind the battery cells 12 in the battery stack 16.

To the coolers 22, a metal material such as aluminum high in heat conductivity is applied, and the coolers 22 are cooled with a coolant circulated from and to a not-shown cooling apparatus. In the battery pack 10, by heat exchange between the battery cells 12 and the coolers 22, heat of the battery cells 12 can be radiated.

Meanwhile, in the battery pack 10, heat conduction portions 30 are provided between the battery stack 16 and the coolers 22, and the heat conduction portions 30 mediate heat conduction between the battery cells 12 of the battery stack 16 and the coolers 22. In the battery pack 10, surfaces of the battery stack 16 on the sides of the coolers 22 are covered by the band bodies 24 of the binding bands 20. Each of the heat conduction portions 30 includes a heat conduction portion 30A between the battery stack 16 and the corresponding one of the band bodies 24 and a heat conduction portion 30B between the corresponding one of the coolers 22 and the band body 24.

For each of the heat conduction portions 30A, 30B, heat conductive sheets 32 are used, each being as a heat conductive member. For the heat conductive sheets 32, members of a metal such as copper may be used, each metal member being formed in a sheet shape. Moreover, for the heat conductive sheets 32, a material excellent in heat conductivity (high in heat conductivity) and having elasticity can be used. In the first embodiment, as an example, graphite sheets are used for the heat conductive sheets 32.

Graphite sheets are produced using graphite and are not only high in heat conductivity in the thickness direction but also more excellent in heat conductivity (heat diffusivity) in the planar direction than silver, copper, aluminum, and the like, and the graphite sheets are excellent in heat diffusivity in the planar direction. Moreover, the graphite sheets are lighter in weight than metals and have elasticity.

As shown in FIG. 1A and FIG. 1B, each of the heat conductive sheets 32 has a strip shape with a predetermined thickness, its longitudinal direction is the stacking direction, and these are arranged between the battery cells 12 of the battery stack 16 and each of the band bodies 24 and between each of the coolers 22 and the corresponding band body 24. Moreover, sets of the heat conductive sheets 32 are arranged in respective spaces between the battery cells 12 of the battery stack 16 and the band body 24 and between the cooler 22 and the band body 24, the heat conductive sheets 32 of each set being arranged in the width direction of the battery pack 10.

Each of the heat conductive sheets 32 is elastically deformed thereby to be curved at its intermediate portion in the width direction and is formed into a substantially U-shape as viewed through the longitudinal direction, and the heat conductive sheet 32 has a shape in which a curved portion 34 is formed at the intermediate portion in the width direction and the curved portion 34 connects end portions 36 on both sides in the width direction. That is, to the heat conductive sheets 32, a shape of curving into the substantially U-shape is applied as a displacement absorbing structure for absorbing a displacement in arrangement distance.

In the heat conduction portion 30A between the battery cells 12 and the band body 24, one of the end portions 36 of each of the heat conductive sheets 32 is brought into surface contact with the battery cells 12, and the other of the end portions 36 is brought into surface contact with the band body 24. Moreover, in the heat conduction portion 30B between the cooler 22 and the band body 24, one of the end portions 36 of each of the heat conductive sheets 32 is brought into surface contact with the cooler 22, and the other of the end portions 36 is brought into surface contact with the band body 24. The end portions 36 of the heat conductive sheets 32 are joined to the battery cells 12, the coolers 22, and the band bodies 24 by adhesion on the surface contact regions or a similar method. Thereby, in the battery pack 10, the battery cells 12 and the coolers 22 are thermally connected with the heat conductive sheets 32.

The battery pack 10 configured as above includes the battery stack 16 in which the battery cells 12 are stacked. By the battery cells 12 discharging, the battery pack 10 outputs direct current electric power at a predetermined voltage, and by the direct current electric power being input, the battery cells 12 are charged. As to each of the battery cells 12, heat is generated in charging and in discharging to raise its temperature, and by the temperature being kept in a proper temperature range, battery performance such as discharge performance and charge performance is kept in a proper range.

In the battery pack 10, the battery stack 16 is bound by the binding bands 20, and the coolers 22 are disposed. Moreover, in the battery pack 10, the heat conduction portion 30A is arranged between the battery stack 16 and the band body 24 of the binding band 20, and the heat conduction portion 30B is arranged between the cooler 22 and the band body 24.

For the heat conduction portions 30A, 30B, the heat conductive sheets 32 are used, and the heat conductive sheets 32 thermally connect the battery cells 12 of the battery stack 16 and the coolers 22 via the band bodies 24. Thereby, in the battery pack 10, heat of the battery cells 12 is conducted to the coolers 22 via the heat conductive sheets 32, and thereby, heat radiated from the battery cells 12 is conducted to the coolers 22 to be radiated. Accordingly, as to the battery pack 10, temperature rise caused by heat generation in charging of and in discharging of the battery cells 12 is restrained, and a battery function is restrained from deteriorating.

Moreover, to the heat conductive sheets 32, graphite sheets having heat conductivity high in planar direction are applied, and the heat conductive sheets 32 are used such that heat is conducted in the width direction which is one direction in the planar direction of the graphite sheets. Therefore, the heat conductive sheets 32 can effectively perform heat conduction between the battery cells 12 and the coolers 22, and heat can be effectively radiated from the battery cells 12.

Now, in the battery pack 10, expansion and contraction of the battery cells 12 occasionally occur in charging and in discharging. In the battery pack 10, when expansion of the battery cells 12 occurs, the bent portions 26 of each of the binding bands 20 receive, from the end plates 14, forces (pressing forces) in directions of separating from each other. Thereby, in the battery pack 10, a curve that is substantially convex upward or downward occasionally arises on the band body 24 of the binding band 20, and in the battery pack 10, when such a curve arises on the band body 24, distances between the battery cells 12 and the band body 24 and a distance between the cooler 22 and the band body 24 vary.

In this stage, in the battery pack 10, if the heat conductive sheets 32 are restrained from being deformed (are hardly deformed), the end portions 36 are occasionally peeled off from the battery cell 12, the cooler 22, or the band body 24. In the battery pack 10, by the end portions 36 of the heat conductive sheets 32 being peeled off from the battery cell 12, cooler 22, or the band body 24, heat conduction efficiency between the battery cells 12 and the cooler 22 occasionally deteriorates, which results in deterioration of battery performance.

Here, each of the heat conductive sheets 32 is deformed to be curved into a substantially U-shape as viewed through the longitudinal direction. Therefore, in the battery pack 10, even when distances between the battery cells 12 and the band bodies 24 and distances between the coolers 22 and the band bodies 24 vary, the heat conductive sheets 32 are deformed so as to follow the changes. That is, each of the heat conductive sheets 32 is deformed such that the curve of the curved portion 34 becomes more gradual, when the distance between the end portions 36 on both sides is widened. Moreover, each of the heat conductive sheets 32 is deformed such that the curve of the curved portion 34 becomes steeper, when the distance between the end portions 36 on both sides is narrowed.

Thereby, in the battery pack 10, even when a curve arises on the band body 24 of the binding band 20, each of the end portions 36 of the heat conductive sheets 32 is restrained from being peeled off from the battery cell 12, the cooler 22, or the band body 24. Accordingly, in the battery pack 10, heat conduction efficiency between the battery cells 12 and the coolers 22 does not deteriorate, and heat generated from the battery cells 12 can be effectively restrained using the coolers 22.

Moreover, the graphite sheets are used for the heat conductive sheets 32, and the heat conductive sheets 32 can be elastically deformed. Therefore, the heat conductive sheets 32 can be elastically deformed so as to follow changes of the distances between the battery cells 12 and band bodies 24 and changes of the distances between the band bodies 24 and the coolers 22. That is, when for the heat conductive sheets 32, a material that is hardly elastically deformed (material that is plastically deformed), such as a metal material, is used, by the distance between the end portions 36 being widened, there arises a possibility that the end portions 36 are peeled off from the battery cell 12, the cooler 22, or the band body 24.

In contrast, in the battery pack 10, by the heat conductive sheets 32 being elastically deformed, the end portions 36 are not peeled off. Thereby, in the battery pack 10, by the heat conductive sheets 32 being used in the heat conduction portions 30A, 30B, heat from the battery cells 12 can be kept effectively radiated using the coolers 22.

Next, modifications of the first embodiment are described with reference to the drawings. Note that a basic configuration of each of the modifications described below is similar to that of the first embodiment.

### Modification 1

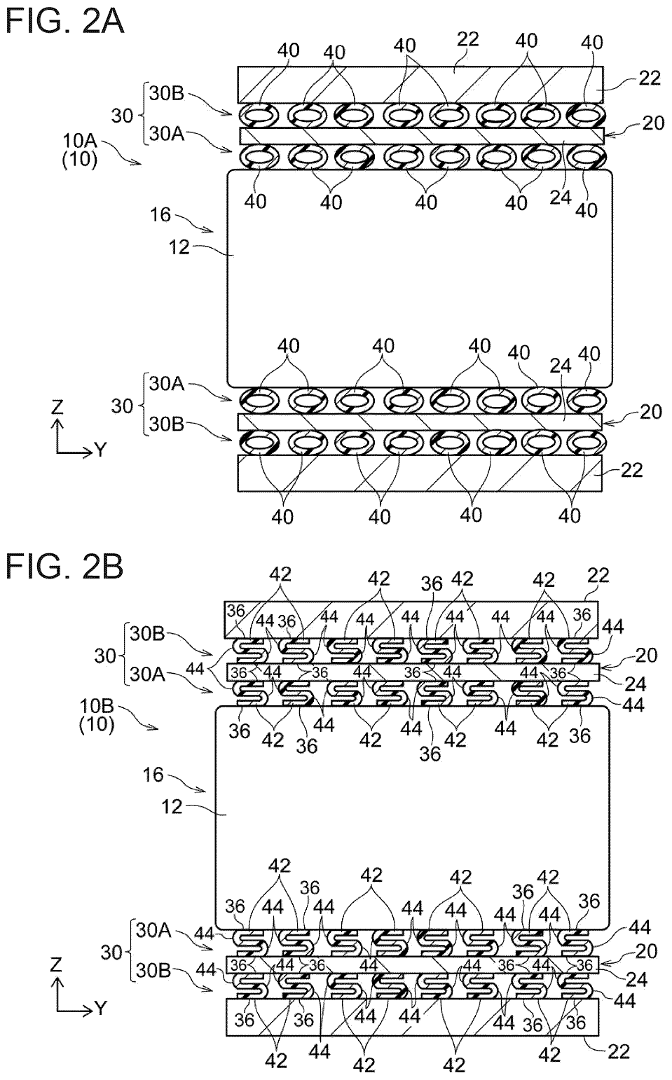

In the first embodiment, each of the heat conductive sheets 32 is curved in a substantially U-shape and used. Nonetheless, a sectional shape of a heat conductive member is not limited to this. FIG. 2A shows the main portion of a battery pack 10A according to Modification 1 as a schematic sectional view as viewed through the stacking direction.

As shown in FIG. 2A, in Modification 1, heat conductive sheets 40 each being as the heat conductive member are applied. For the heat conductive sheets 40, the material similar to that for the heat conductive sheets 32 can be used. Moreover, each of the heat conductive sheets 40 has a section of a substantially circle (or ellipse), the section being taken along a direction intersecting the longitudinal direction, the heat conductive sheet 40 has a shape in which the end portions 36 of two of the heat conductive sheets 32 are connected.

In the battery pack 10A, the heat conductive sheets 40 are arranged in place of the heat conductive sheets 32 of the battery pack 10. Moreover, each of the heat conductive sheets 40 is elastically deformed thereby to be curved into a substantially elliptic shape and is brought into surface contact with the battery cells 12, the cooler 22, or the band body 24, and joining of each of the surface contact regions is performed.

In the battery pack 10A configured as above, the heat conductive sheets 40 are deformed so as to follow change of the distances between the battery cells 12 and the band body 24 and are deformed so as to follow change of the distance between the cooler 22 and the band body 24. Therefore, the battery pack 10A in which the heat conductive sheets 40 are used can afford similar effects to those of the battery pack 10 in which the heat conductive sheets 32 are used.

Note that, depending on the changes of the distances between the battery cells 12 and the band body 24 and the distance between the cooler 22 and the band body 24, dimensions of each of the heat conductive sheets 40 along the width direction of the battery stack 16 vary, and the contact area of each of these varies. Accordingly, the heat conductive sheets 40 may be arranged in consideration of the contact areas at the time when the distances are widened and the dimensions at the time when the distances are narrowed.

### Modification 2

FIG. 2B shows the main portion of a battery pack 10B according to Modification 2 as a schematic sectional view as viewed through the stacking direction.

As shown in FIG. 2B, in Modification 2, heat conductive sheets 42 each being as the heat conductive member are applied, and for the heat conductive sheets 42, the material similar to that for the heat conductive sheets 32 can be used. Moreover, as to each of the heat conductive sheets 42, its intermediate portion between the end portions 36 on both sides in the width direction is folded a plurality of times, and the heat conductive sheet 42 has the intermediate portion in the width direction folded twice. Thereby, the heat conductive sheet 42 has a substantially S-shape in which two curved portions 44 are formed between the end portions 36.

In the battery pack 10B, the heat conductive sheets 42 are arranged in place of the heat conductive sheets 32 of the battery pack 10, and each of the end portions 36 is brought into surface contact with and joined to any of the battery cells 12, the cooler 22, and the band body 24.

In the battery pack 10B configured as above, the heat conductive sheets 42 are deformed so as to follow change of the distances between the battery cells 12 and the band body 24 and are deformed so as to follow change of the distance between the cooler 22 and the band body 24. Therefore, the battery pack 10B in which the heat conductive sheets 42 are used can afford similar effects to those of the battery pack 10 in which the heat conductive sheets 32 are used.

Moreover, since each of the heat conductive sheets 42 can have a longer width dimension than the heat conductive sheets 32, those can be deformed so as to follow even larger changes in distance than the heat conductive sheets 32. Furthermore, each of the heat conductive sheets 42 includes the curved portions 44 between the end portions 36, and thereby, the change in width dimension relative to the change in distance between the end portions 36 is reduced. Since the heat conductive sheets 42 can thereby be arranged at narrower distances than the heat conductive sheets 32, 40, heat conduction efficiency between the battery cells 12 and the coolers 22 can be enhanced.

### Modification 3

While in the first embodiment, the heat conductive sheets 32 are arranged in the width direction of the battery stack 16, the heat conductive members may be arranged in the stacking direction of battery cells in a battery pack, where the longitudinal direction is the width direction of the battery pack.

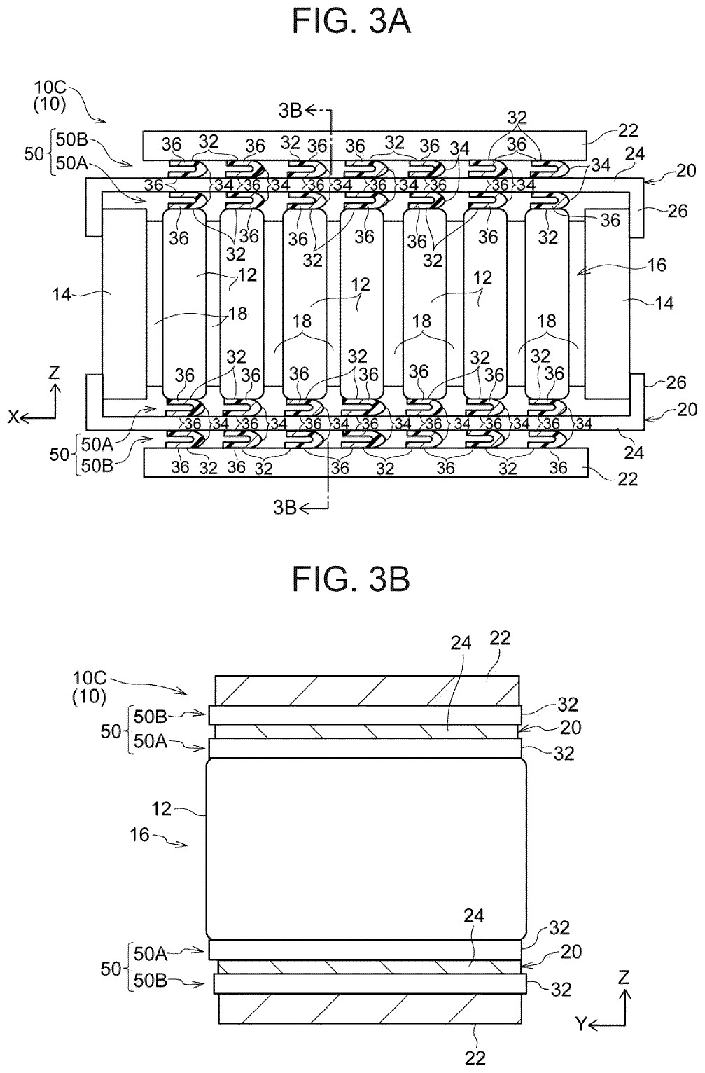

FIG. 3A shows a battery pack 10C according to Modification 3 as a schematic configurational view in lateral view, and FIG. 3B shows a schematic section of the main portion of the battery pack 10C as a sectional view taken along the 3B-3B line in FIG. 3A.

As shown in FIG. 3A and FIG. 3B, in the battery pack 10C, the heat conductive sheets 32 are arranged in heat conduction portions 50 between the battery stack 16 and the coolers 22. Sets of the heat conductive sheets 32 are respectively arranged in a heat conduction portion 50A between the battery stack 16 and the band body 24 and in a heat conduction portion 50B between the cooler 22 and the band body 24, their longitudinal direction being the width direction of the battery stack 16, and those of each set are arranged in the stacking direction. Moreover, each of the end portions 36 of each of the heat conductive sheets 32 is brought into surface contact with and joined to the battery cell 12, the cooler 22, or the band body 24.

The battery pack 10C configured as above can also afford similar effects to those of the battery pack 10. Note that, in the battery pack 10C, the heat conductive sheets 40, 42 may be arranged in place of the heat conductive sheets 32.

### Modification 4

In the first embodiment and Modification 1 to Modification 3, the heat conductive sheets 32, 40, 42 to which the displacement absorbing structure is applied are arranged between the battery stack 16 and the band body 24 and between the cooler 22 and the band body 24. Nonetheless, the heat conductive members may be arranged at least one of spaces between the battery cells 12 and the band body 24 and between the cooler 22 and the band body 24.

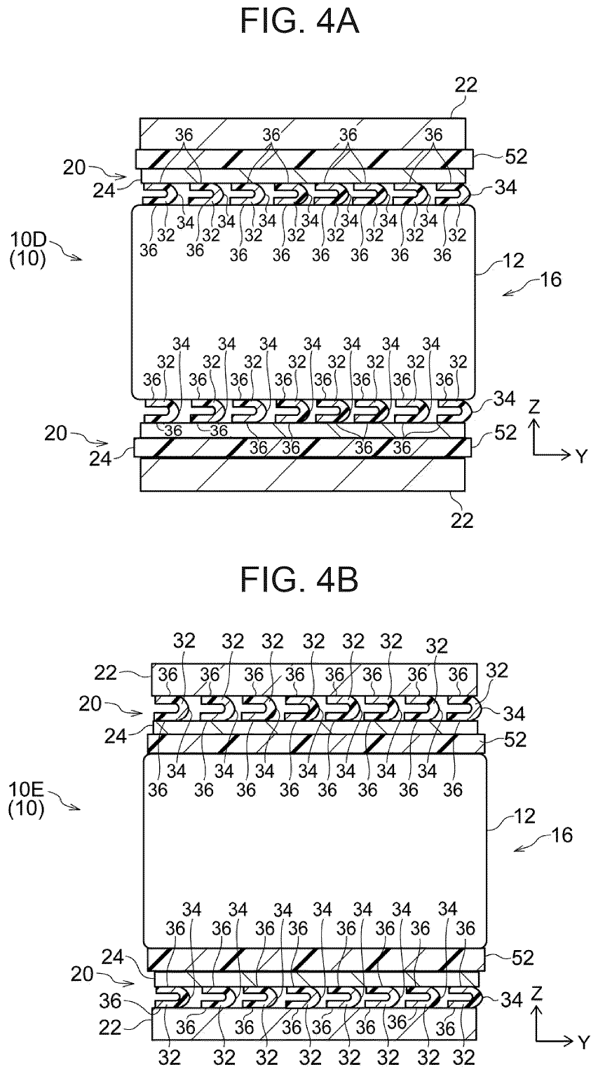

FIG. 4A shows the main part of a battery pack 10D as an example of a battery pack according to Modification 4 as a sectional view as viewed through the stacking direction, and FIG. 4B shows the main part of a battery pack 10E as another example of the battery pack according to Modification 4 as a sectional view as viewed through the stacking direction. Note that FIG. 4A and FIG. 4B are sectional views similar to that of FIG. 1B.

When each of the sheet-shaped heat conductive members is joined, one of surfaces of the heat conductive member being as the battery cell side, another of the surfaces of the heat conductive member being as the cooling member side, there arises concern of peeling-off, cracks, or the like on the heat conductive member due to large widening of the distance between the binding member and the battery cell or the cooling member caused by a curve or the like of the binding member. In contrast, when change in the distance is small or the distance is narrowed caused by a curve or the like of the binding member, there is less concern of peeling-off or the like on the sheet-shaped heat conductive member.

As to the battery pack 10D shown in FIG. 4A, when a curve or the like arises on the band body 24, while there is low concern of widening of the distance between the cooler 22 and the band body 24, there is high concern of widening of the distance between the battery cells 12 and the band body.

In the battery pack 10D, the heat conductive sheets 32 are arranged between the battery cells 12 and the band body 24. Moreover, in the battery pack 10D, each of heat conductive sheets 52 is arranged between the cooler 22 and the band body 24. For each of the heat conductive sheets 52, a graphite sheet or the like is used, one of surfaces of the heat conductive sheet 52 is brought into surface contact with and joined to the cooler 22, and another of the surfaces is brought into surface contact with and joined to the band body 24.

Moreover, as to the battery pack 10E shown in FIG. 4B, when a curve or the like arises on the band body 24, while there is low concern of widening of the distance between the battery cells 12 and the band body 24, there is high concern of widening of the distance between the cooler 22 and the band body.

In the battery pack 10E, the heat conductive sheets 32 are arranged between the cooler 22 and the band body 24. Moreover, in the battery pack 10E, each of the heat conductive sheets 52 is arranged between the battery cells 12 and the band body 24, one of the surfaces of the heat conductive sheet 52 is brought into surface contact with and joined to the battery cells 12, and another of the surfaces is brought into surface contact with and joined to the band body 24.

Also with the battery pack 10D, 10E configured as above, heat radiation from the battery cells 12 can be kept radiated using the coolers 22 similarly to the battery pack 10, and similar effects to those of the battery pack 10 can be obtained. Note that, in the battery pack 10D, 10E, the heat conductive sheets 40, 42 may be arranged in place of the heat conductive sheets 32.

### Second Embodiment

Next, a second embodiment is described. A basic configuration of the second embodiment is similar to that of the first embodiment. In the second embodiment, similar functional components to those for the first embodiment and Modification 1 to Modification 4 are given similar signs, and their description is omitted.

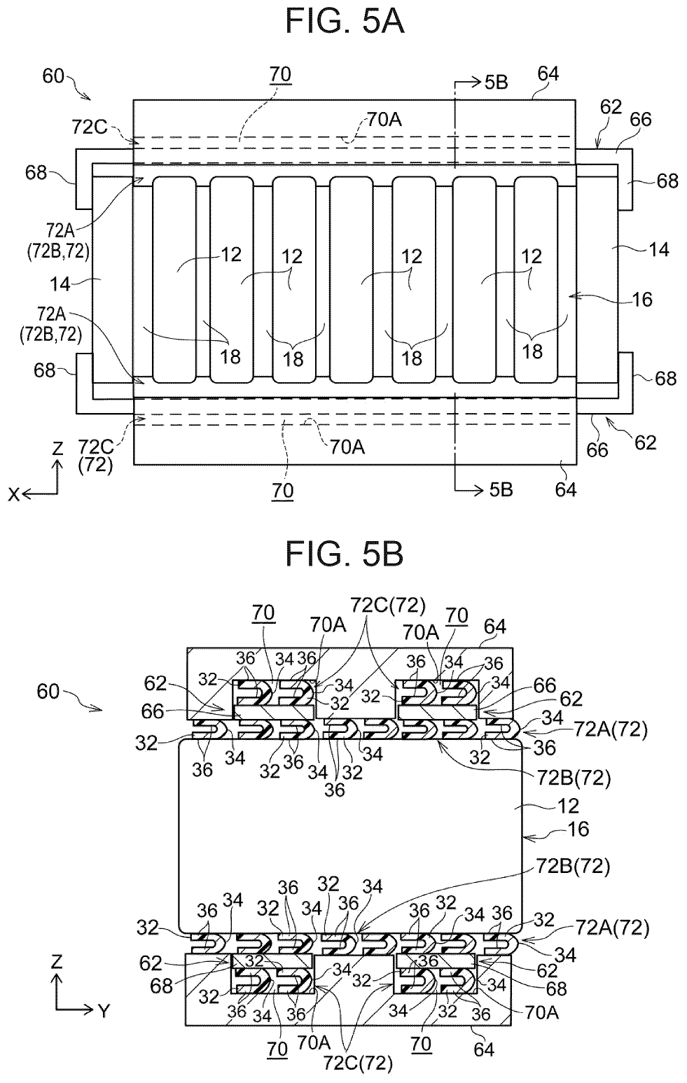

FIG. 5A shows a battery pack 60 according to the second embodiment as a schematic configurational view in lateral view, and FIG. 5B shows a schematic section of the main portion of the battery pack 60 according to the second embodiment as a sectional view taken along the 5B-5B line in FIG. 5A.

As shown in FIG. 5A and FIG. 5B, the battery pack 60 includes binding bands 62 each being as the binding member, and coolers 64 each being as the cooling member. The binding bands 62 are arranged in the battery pack 60 in place of the binding bands 20 of the battery pack 10. Moreover, the coolers 64 are arranged in the battery pack 60 in place of the coolers 22 of the battery pack 10.

Each of the binding bands 62 is metal-made using iron or the like which high load-bearing capacity can be obtained from, and the binding band 62 includes strip-shaped band bodies 66, and bent portions 68 formed by bending both end portions of the band bodies 66 in the longitudinal direction.

The binding bands 62 as a plurality of strips can be used for the battery pack 60, and for the battery pack 60, two binding bands 62 are used. In each of the binding bands 62, the longitudinal direction of the band bodies 66 being the stacking direction, the binding band 62 has two band bodies 66 arranged to be spaced at a predetermined distance in intermediate portions in the width direction of the battery stack 16 of the battery pack 60.

As to each of the binding bands 62, the bent portions 68 are arranged to be in contact with outer surfaces of the end plates 14 in the stacking direction, and the bent portions 68 are fastened and fixed to the end plates 14 to be attached to the battery stack 16 and be assembled to the battery pack 60. By the bent portions 68 giving external forces in such directions that the end plates 14 come close to each other, the binding bands 62 bind the battery cells 12 in the battery stack 16.

In each of the coolers 64, a plurality of recess portions 70 is formed on the surface that faces the battery stack 16. Each of the recess portions 70 opens into a substantially rectangular shape as viewed through the stacking direction, and by extending in the stacking direction, the opening is formed into a groove shape in the cooler 64. Moreover, the recess portions 70 are formed to meet positions of the band bodies 66, and the band bodies 66 are housed in the recess portions 70.

In the battery pack 60, heat conduction portions 72 are arranged between the battery stack 16 and each of the coolers 64. The heat conduction portions 72 include heat conduction portions 72A between the battery stack 16 and the cooler 64, heat conduction portions 72B between the battery stack 16 and the band bodies 66, and heat conduction portions 72C each being between a bottom surface 70A of the recess portion 70 of the cooler 64 and the corresponding band body 66. In each of the heat conduction portions 72A, 72B, 72C, the heat conductive sheets 32 are arranged in the width direction of the battery stack 16, the longitudinal direction being the stacking direction.

In the heat conduction portions 72A, one of the end portions 36 of each of the heat conductive sheets 32 is brought into surface contact with and joined to the battery cells 12, and the other of the end portions 36 is brought into surface contact with and joined to the cooler 64. Moreover, in the heat conduction portions 72B, one of the end portions 36 of each of the heat conductive sheets 32 is brought into surface contact with and joined to the battery cells 12, and the other of the end portions 36 is brought into surface contact with and joined to the band body 66. Furthermore, in the heat conduction portions 72C, one of the end portions 36 of each of the heat conductive sheets 32 is brought into surface contact with and joined to the band body 66, and the other of the end portions 36 is brought into surface contact with and joined to the cooler 64 (bottom surface 70A of the recess portion 70) in the recess portion 70.

In the battery pack 60 configured as above, the coolers 64 face the battery stack 16, and the binding bands 20 arranged between the battery stack 16 and the coolers 64 bind the battery cells 12 of the battery stack 16. Moreover, in the battery pack 60, the heat conductive sheets 32 are arranged between the battery cells 12 and each of the coolers 64, between the battery cells 12 and each of the band bodies 66, and between the coolers 64 and the band bodies 66.

Therefore, in the battery pack 60, even when the distances between the battery cells 12 and the cooler 64 vary, and thereby, the distances between the cooler 64 and the band bodies 66 in the recess portions 70 vary, the heat conductive sheets 32 are elastically deformed so as to follow the changes of the distances. Moreover, in the battery pack 60, even when the distances between the battery cells 12 and the band bodies 66 vary and the distances between the cooler 64 and the band bodies 66 in the recess portions 70 vary, the heat conductive sheets 32 are deformed so as to follow the changes of the distances.

Thereby, in the battery pack 60, even when a curve arises on the band body 66 of the binding band 62, the end portions 36 of the heat conductive sheets 32 are restrained from being peeled off from the battery cell 12, the cooler 64, or the band body 66. Accordingly, in the battery pack 60, heat conduction efficiency between the battery cells 12 and the coolers 64 does not deteriorate, and heat generated from the battery cells 12 can be effectively restrained using the coolers 64.

Moreover, in the battery pack 60, the heat conductive sheets 32 employ the graphite sheets and can be elastically deformed. Thereby, in the battery pack 60, since each of the heat conductive sheets 32 can be elastically deformed according to change of the distance between the end portions 36 on both sides, the end portions 36 are not peeled off and are not displaced, and heat from the battery cells 12 can be kept effectively radiated using the coolers 64. Note that the heat conductive sheets 40, 42 can also be applied to the battery pack 60 in place of the heat conductive sheets 32.

### Third Embodiment

Next, a third embodiment is described. Note that a basic configuration of the third embodiment is similar to that of the first embodiment. In the third embodiment, similar functional components to those for the first embodiment, the second embodiment, and Modification 1 to Modification 4 are given similar signs, and their description is omitted.

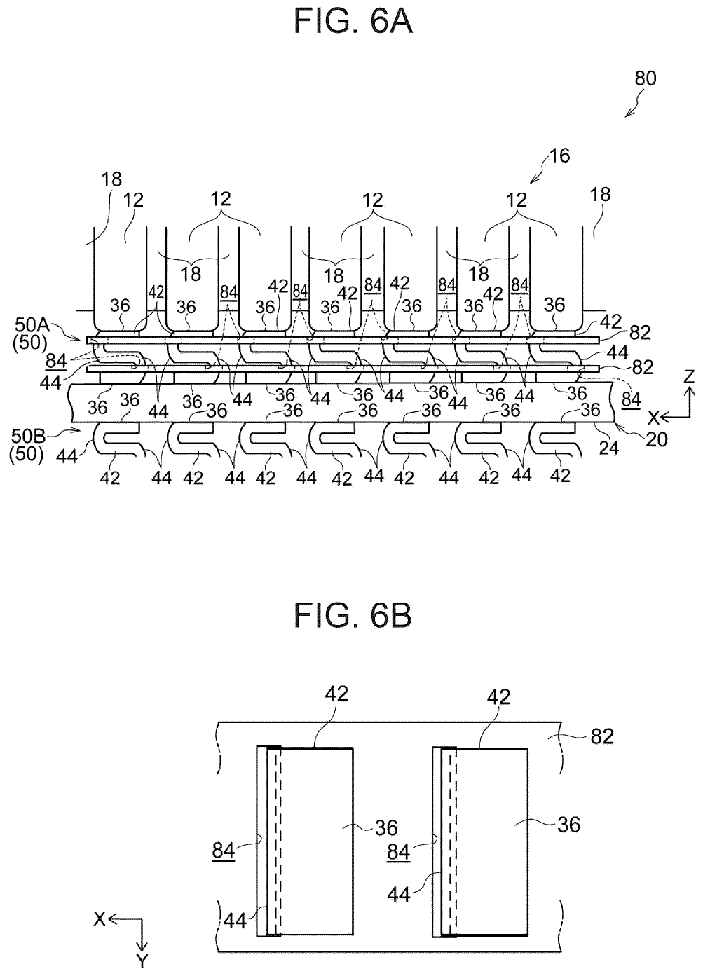

FIG. 6A shows a main portion of a battery pack 80 according to the second embodiment as a schematic configurational view in lateral view, and FIG. 6B shows a main portion of the battery pack 80 as a plan view as viewed from the battery stack 16 side. Note that FIG. 6B is a plan view of the main portion of a heat conduction plate 82 below.

As shown in FIG. 6A, in the battery pack 80, the end plates 14 are arranged on the battery stack 16 in which the battery cells 12 are stacked, and by the end plates 14 being compressed by the bent portions 26 of the binding bands 20, the battery cells 12 are bound.

Moreover, in the battery pack 80, the cooler 22 (its illustration is omitted) is arranged on the opposite side of each of the band bodies 24 from the battery stack 16. In the battery pack 80, the heat conductive sheets 42 are arranged between the battery stack 16 and the band body 24 and between the cooler 22 and the band body 24, and each of the end portions 36 of each of the heat conductive sheets 42 is brought into surface contact with and joined to the battery cell 12, the cooler 22, or the band body 24. Thereby, in the battery pack 80, heat from the battery cells 12 can be radiated with the coolers 22.

In the battery pack 80, the heat conductive sheets 42 are arranged in the stacking direction, the longitudinal direction being the width direction of the battery stack 16. The heat conductive sheets 42 that are between the battery stack 16 and the band body 24 are here arranged to be correspond to the respective battery cells 12.

Meanwhile, in the battery pack 80, heat conduction plates 82 are arranged, and between the battery stack 16 and the band body 24, the heat conduction plates 82 are arranged on the battery stack 16 (battery cells 12) side and on the band body 24 side. Each of the heat conduction plates 82 has an elastically deformable plate shape, graphite sheets being used for those. Note that, with no limitation to the plate shape, the heat conduction plate 82 may have a sheet shape or a film shape.

As shown in FIG. 6B, each of the heat conduction plates 82 is formed into a strip shape, and a plurality of slit holes 84 is arranged along the longitudinal direction. Each of the slit holes 84 has a rectangular shape long in the width direction of the heat conduction plate 82 and is formed to penetrate the heat conduction plate 82, and the heat conductive sheets 42 can be inserted through the slit holes 84.

On the battery cell 12 side, the heat conduction plate 82 is brought into surface contact with and joined to a surface, of the end portion 36, that is on the band body 24 side, the end portion 36 being of the heat conductive sheet 42 that is joined to the battery cell 12, and the end portion 36, of this heat conductive sheet 42, that is on the band body 24 side (curved portion 44 side) is drawn through the slit hole 84. Moreover, on the band body 24 side, the heat conduction plate 82 is brought into surface contact with and joined to a surface, of the end portion 36, that is on the battery cell 12 side, the end portion 36 being of the heat conductive sheet 42 that is joined to the band body 24, and the end portion 36, of the heat conductive sheet 42, that is on the battery cell 12 side is drawn through the slit hole 84. Thereby, the heat conduction plates 82 thermally connect the heat conductive sheets 42 both on the battery cell 12 side and on the band body 24 side.

In the battery pack 80 configured as above, the heat conductive sheets 42 are arranged between the battery stack 16 and the band body 24 and between the band body 24 and the cooler 22. Thereby, in the battery pack 80, even when the distances between the battery cells 12 and the band body 24 and the distance between the cooler 22 and the band body 24 vary, since the heat conductive sheets 42 can be elastically deformed according to the changes, similar effects to those of the battery pack 10 can be obtained.

Moreover, in the battery pack 80, the heat conductive sheets 42 brought into surface contact with the battery cells 12 are joined to the heat conduction plates 82. Thereby, in the battery pack 80, temperature differences between the battery cells 12 can be restrained from arising, and the temperatures of the battery cells 12 arranged in the battery stack 16 can be made uniform.

Moreover, with the battery pack 80, since the heat conductive sheets 42 can be beforehand joined to and assembled to the heat conduction plates 82, assembly ability of the heat conductive sheets 42 to the battery stack 16 can be improved.

What is claimed is:

1. A battery pack comprising:
a stacked body including a plurality of battery cells in a stacking direction;
a cooling member facing at least one surface of surfaces of the stacked body, the surfaces being in a direction intersecting the stacking direction, the cooling member being configured to cool the battery cells on a side of the one surface;
a binding member that compresses the stacked body at both end portions in the stacking direction to bind the battery cells, the binding member being disposed between the stacked body and the cooling member, the binding member being in a strip shape; and
a heat conduction portion that allows heat to be conducted between the battery cell and the cooling member via a heat conductive member that is in a sheet shape, one side of the heat conductive member in a planar direction being joined to a side of the battery cell, another side of the heat conductive member in the planar direction being joined to a side of the cooling member, an intermediate portion of the heat conductive member being in a curved shape, the one side, the other side, and the intermediate portion being between the battery cell and the cooling member.

2. The battery pack according to claim 1, wherein:
in the heat conduction portion, a plurality of the heat conductive members is disposed in the stacking direction of the battery cells; and
the heat conduction portion includes a heat conduction plate that thermally connects the heat conductive members, the heat conduction plate being configured to enable heat to be conducted between the heat conductive members.

3. The battery pack according to claim 1, wherein:
the heat conductive member is disposed between the battery cell and the binding member and between the binding member and the cooling member; and
the heat conductive member is enabled to be elastically deformed according to changes of a distance between the battery cell and the binding member and a distance between the binding member and the cooling member.
